(19) United States
(12) Patent Application Publication
(10) Pub. No.: US 2014/0248590 A1
(43) Pub. Date: Sep. 4, 2014

(54) KEYBOARD FOR ENTERING TEXT AND LEARNING TO READ, WRITE AND SPELL IN A FIRST LANGUAGE AND TO LEARN A NEW LANGUAGE

(71) Applicant: Learning Circle Kids LLC, Camas, WA (US)

(72) Inventor: Ann H. McCormick, Leavenworth, WA (US)

(73) Assignee: Learning Circle Kids LLC, Camas, WA (US)

(21) Appl. No.: 14/067,426

(22) Filed: Oct. 30, 2013

Related U.S. Application Data
(60) Provisional application No. 61/771,558, filed on Mar. 1, 2013.

(51) Int. Cl. G09B 17/00; G09B 19/06

(52) U.S. Cl. CPC G09B 17/003; G09B 19/06
USPC 434/157; 434/169; 434/163; 434/159

(57) ABSTRACT

A novel keyboard made up vowel daisies is used to learn to read, write and spell in English. A story is presented in which a specific set of words that can be generated emphasized. Upon hearing the story, a user enters a response which is received by the device when the specific word is highlighted in the story. A letter configuration, such as a hexagonal ring of letters corresponding to the specific word is displayed on the device. A phonic data relating to a letter in the specific word is manifested at the same time as another characteristic or attribute of the letter, specifically the shape of the letter, is also displayed or manifested to the user. These are done concurrently with displaying the letter configuration that corresponds to the word, wherein the letters are all in the same daisy array.

### CROSS-REFERENCE TO RELATED APPLICATIONS

This application claims priority under U.S.C. §119(e) to pending U.S. Provisional Application No. 61/771,558 filed Mar. 1, 2013, entitled “TOUCH ACTIVATED KEYBOARD FOR LEARNING A LANGUAGE AND ENTERING TEXT”, which is hereby incorporated by reference in its entirety.

### TECHNICAL FIELD

The present invention relates generally to software and text entry systems. More specifically, it relates to hardware devices and software for implementing a keyboard for entering text and to facilitate learning to read, write and spell in English; to learn English as a new language, or (with an appropriate keyboard array), learn to read, write and spell in another phonetic language, or to learn that new language.

### BACKGROUND OF THE INVENTION

The conventional keyboard that is in widespread use today, known as the QWERTY keyboard, has been in use for over 80 years. Because of the mechanical limitations of early text entry apparatus, namely the typewriter, makers of such equipment wanted to prevent users from typing too fast, in order to prevent jamming of mechanical parts. As a result, keys were positioned to impede the user's typing speed. The keyboard that was devised was the QWERTY keyboard and is the one in use today. Although mechanical limitations for text entry systems were overcome decades ago with the advent of the electronic typewriter and the digital era, the same configuration of keys intended to slow down the user is still being used. Users, including adults and children as young as two, simply get used to placement of the letters or keys and over time become proficient.

However, the digital apparatus used with text entry systems has been evolving. Desktop and laptop computers have long used physical keyboards where users press down on physical keys. With the introduction of mobile devices, primarily mobile phones (referred to as “smartphones” herein) and tablet computing devices, the physical keyboard or a keyboard with some form of physical keys, is being replaced with touch-screen keyboards, also referred to as keypads. Such keypads are now in widespread use on smartphones and tablets that, by virtue of their design, do not accommodate physical keypads (although physical keyboards can be used as accessories to such devices). Currently, the touch-screen keypad is the most convenient and, at the moment, most preferred method of entering text on mobile devices. The configuration and layout of such keypads can be configured on the displays of mobile devices through software. Nevertheless, the touch-screen or touch-activated keyboards used on nearly all English-based, 21st-century mobile devices still use the QWERTY configuration from the early 1900s.

As noted, users have gotten accustomed, from an early age, to using this configuration of the keyboard. However, it has not proven efficient or effective in teaching users, in most cases young children (e.g., ages 3-6) or adults learning English, how to read, spell, and write. The ordering and layout of the letters on a standard keyboard is not conducive to learning to read, write and spell in English. For example, users, such as children, when typing words, have to find sequences of letters that were arranged to discourage forming words rapidly. This can lead to confusion and lack of focus on what is being taught. Conventional keyboards are not configured to facilitate streamlined, efficient learning of reading, writing and spelling or learning new language. Furthermore, the arrangement of the letters on the conventional keyboard in fact hinders learning new words, such as simple three-letter words. It would be desirable to have a keyboard that is part of a text-entry system having a configuration of letters that facilitates learning to read, write and spell.

### SUMMARY OF THE DESCRIBED EMBODIMENTS

An app that allows bridging from letters to words to stories. Users hear letter sounds, one sound per letter, short vowels and one sound for consonants, and trace letter shapes, one shape per letter, lower case, for a few letters at a time, seven or fewer. The user blends these letter sounds and shapes into CVC and VCC words. The user then finds these three-letter words in stories and taps the words to trigger animations that show their meanings. Finally, the user applies what he or she learned by typing the 3-letter words freely in a game. All this is done in a steep progression (e.g., 15 minutes).

One aspect of the present invention is a method of learning to read, write and spell in English. A story is presented in which a specific set of words that can be generated emphasized. The story is presented on a touch-activated screen of a device having a processor, a memory, and a touch screen. Upon hearing the story, a user enters a response which is received by the device when the specific word is highlighted in the story. A letter configuration, such as a hexagonal ring of letters, also referred to as a daisy array, that corresponds to the specific word is displayed on the device. A phonic data item or phoneme relating to a letter in the specific word is manifested at the same time as another characteristic or attribute of the letter, specifically the shape of the letter, is also displayed or manifested to the user. In one embodiment, these are done concurrently with displaying the letter configuration that corresponds to the word, wherein the letters are all in the same daisy array. In one embodiment, no other data relating to the word or letters are presented to the user, minimizing the data or information about the letters and word presented to the user and thereby reducing the possibility of confusion when learning to read and write the English word.

In another aspect of the invention, a system for teaching how to read and write in English and enter text using a new keyboard is described. The system includes a phonic generator module for providing phonics data relating to a word or letter concurrently with displaying a hexagonal array or vowel daisy corresponding to the word. The system presents one sound and one shape for a letter at the same time, such that the user of the system is presented with only phonics data (e.g., the sound and shape of a letter) and no other data relating to the letter or word. The system also includes a touch-activated screen (“touch screen display”) displaying a hexagonal ring keyboard. In one embodiment, the hexagonal ring keyboard is comprised of five daisy arrays and five edge letters (consonants). The daisy arrays have a vowel at the center of each: a, e, i, o, and u. The consonants surrounding each vowel is as follows: an “a” key surrounded by keys for m, s, c, n, h, and t, an “e” key surrounded by keys for h, n d, r, p, and f, an “i” key surrounded by keys for w, j, m, t, n, and g, an “o” key surrounded by keys for s, f, p, d, t, and l, and a “u” key surrounded by keys for q, g, n, b, f, and r. The five edge letters are v, k, x, y, and z.

Another aspect of the present invention is an alphabet input device having a processor, a network interface, a memory, and a display component. The display component displays a vowel key expressing a specific vowel with an image of an object corresponding to the vowel, which upon activation expresses the specific vowel, such as providing audio output of one phoneme corresponding to the vowel. The display component also displays a consonant key expressing a specific consonant with an image of an object corresponding to the consonant, which upon activation expresses the specific vowel, such as providing audio output of one phoneme corresponding to the consonant. In one embodiment, the vowel key is adjacent to multiple consonant keys such that at least one consonant key is placed between two vowel keys forming a daisy array or daisy chain arrangement.

### BRIEF DESCRIPTION OF THE DRAWINGS

The invention and the advantages thereof may best be understood by reference to the following description taken in conjunction with the accompanying drawings in which:

FIG. 1 is an illustration of an example of a vowel-daisy in accordance with one embodiment of the present invention;

FIGS. 2 and 3 are illustrations of other hexagon-shaped key arrays in accordance with alternative embodiments of the present invention;

FIG. 4 is an illustration of an example of a hexagonal array of keys corresponding to a specific subset of English letters in accordance with one embodiment;

FIG. 5 are illustrations of other examples of hexagonal arrays of keys corresponding to the other subsets of English letters and keywords corresponding to the letters;

FIG. 6 is an illustration of a keyboard comprised of five vowel-daisies and five consonant letters in accordance with one embodiment;

FIG. 7 is a is an illustration of the keyboard showing edge letters in accordance with one embodiment;

FIG. 8. is an illustration of a daisy keyboard showing only letters without keyword pictures in accordance with an alternative embodiment;

FIG. 9 shows sample daisy words from segments of vowel-daisies in accordance with one embodiment;

FIG. 10 shows an example of tracing a letter using arrows in accordance with one embodiment;

FIG. 11 is a sample screenshot of a wordbook showing a keyword picture and keyword and a vowel daisy for the letter “a” in accordance with one embodiment;

FIG. 12 is a sample screenshot showing a wordbook showing multiple words from the word lists for the “a” vowel daisy in accordance with one embodiment; and

FIGS. 13A and 13B are diagrams of a computing device suitable for implementing embodiments of the present invention.

In the drawings, like reference numerals are sometimes used to designate like structural elements. It should also be appreciated that the depictions in the figures are diagrammatic and not to scale.

### DETAILED DESCRIPTION OF VARIOUS EMBODIMENTS

Methods and systems for entering text and learning a new language are described in the accompanying figures. A device having a touch-screen display shows a configuration of keys which comprise a keypad and which executes software for learning how to read, write and spell a phonetic language (e.g. not Mandarin characters) and learn a new language, as well as for other purposes is described. In one embodiment, the device is a mobile device, such as a smartphone or tablet and the language is English. In other embodiments, the device may be a laptop or desktop computer with a touch screen or a wearable device, such as a bracelet. The keypad may operate physical devices that have touch-sensitive, flat-panel displays, such as computer-based controllers for automobiles, HVAC systems, appliances, game consoles, cash registers and other devices that work with text and graphical input, including interactive games and Internet search devices attached to a smart television. In one embodiment, the keypad uses a phonetically optimized array of alphabet letters and a small set of control characters that facilitate learning to read, spell, write, and type.

With respect to the typing aspect of the various embodiments, the keypads's alphabetic letters are arranged to optimize speed and efficiency of input, based on study of frequency of occurrence of letters in words of a language, in this case English (the same type of study and resulting arrangement can be done in other languages). In one embodiment, the keys may be arranged in a hexagonal array or another geometrically shaped array. For example, in English, each of the five vowels is surrounded by six consonants. These create formations, described in detail below, referred to as vowel daisies or daisy chains which overlap. Users, including children as young as two-years old, touch the surface of the display component of the mobile device or other input device loaded with software for implementing the keypad and other teaching features of the present invention. As described below, the keypad is also optimized for users, specifically young children, to learn to read, spell, write and become fluent in English.

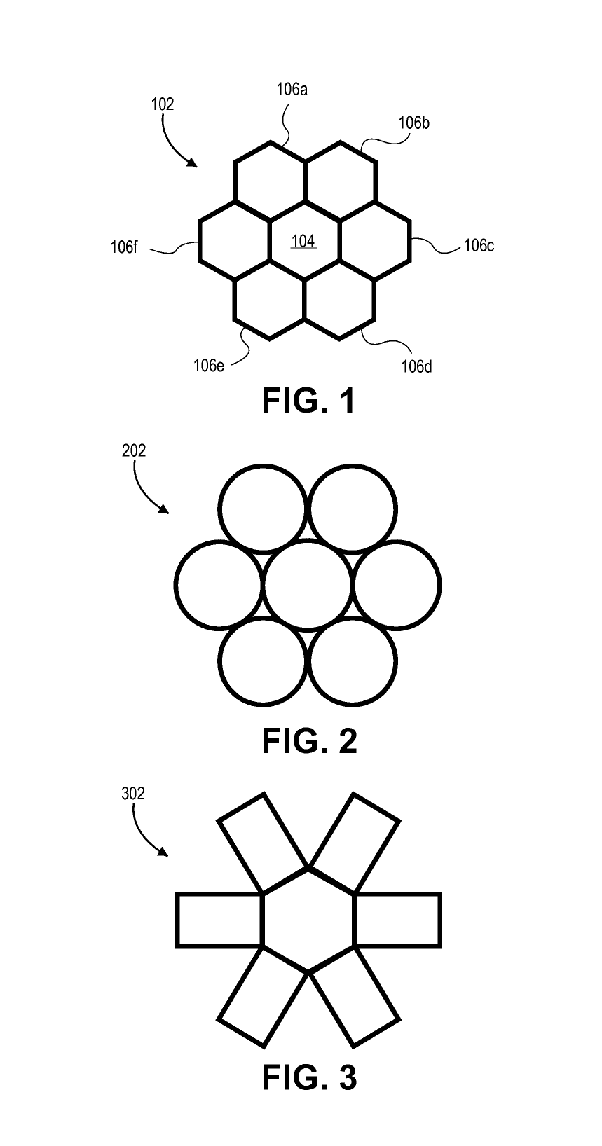

FIG. 1 is an illustration of an example of a vowel-daisy in accordance with one embodiment of the present invention. In this embodiment, the vowel-daisy is a hexagonal array 102 shown without the letters. There are seven hexagon-shaped keys comprising array 102. One of the keys 104 is in the center and is surrounded by six other hexagon-shaped keys 106a-106f. In other embodiments, the keys may have other shapes, such as circular, shown in array 202 in FIG. 2, or a combination of different geometric shapes, such array 302 shown in FIG. 3. Other shapes for the keys and for the array of keys may include diamond, triangular, rectangular, oval, and so on. As noted, in the described embodiment, the shape is a hexagonal array and each key is a hexagon.

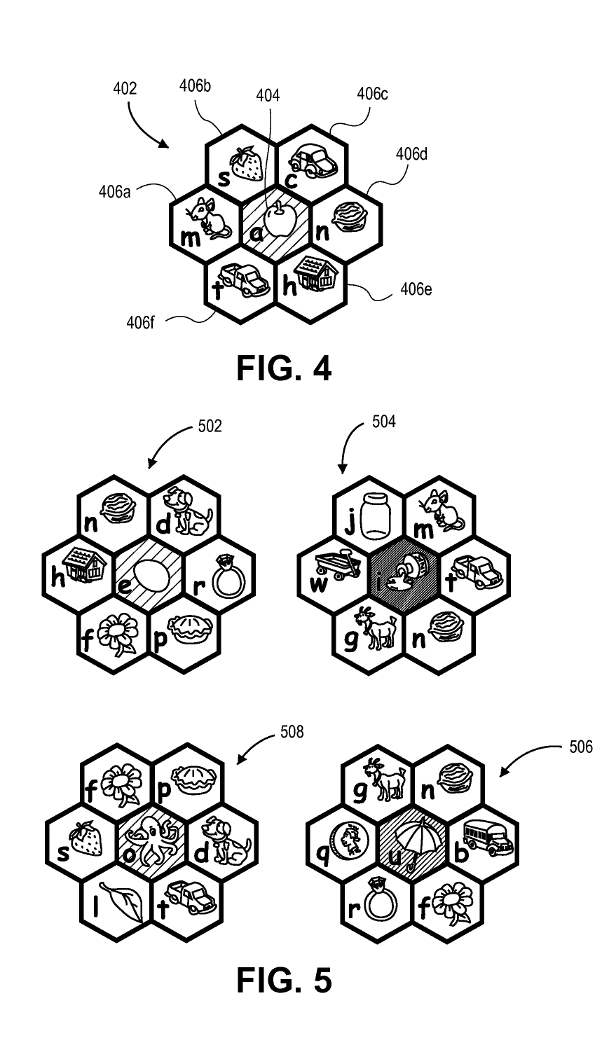

FIG. 4 is an example of a hexagonal array of keys corresponding to a specific subset of English letters in accordance with one embodiment. Each key has a graphical icon or picture corresponding to the letter for that key. At the center of hexagonal array 402 is a vowel key 404, in this case for the letter “a”, displayed in lower case and shown with an icon of an object that starts with the letter, in this case an apple, also referred to as a keyword. The object shown starts with the letter in the key and also has a sound, sometimes referred to herein as a phonetic data item, that provides an example or demonstrates the intended sound of the letter. In this case the phonetic data item for the letter “a” is “aa” for “apple.”Most letters have more than one sound. The keyword is intended to demonstrate the particular intended sound for the letter. The significance of selecting an object (keyword) which has the sound of the letter is explained in more detail below.

The other hexagonal keys surrounding key 404 are consonants, in this example, the letters s, c, n, h, t, and m, each in lower case and, again, each with a keyword that demonstrates the intended phonetic data item, i.e., sound, of the letter. These keys, 406a-f, are configured around key 404 and their selection and arrangement are based on a study of the frequency of the occurrence of particular words, described below. In another embodiment, the keys do not have to display a graphical icon or the icons shown may be different to demonstrate different sounds for the letters. For example, the letter “a” may have a picture of an ape to demonstrate a different phonetic data item for the letter “a” (that is, different from the phonetic sound of “a” in apple). The arrangement of letters shown in keys 406a-f around key 404 may be different. In another embodiment, upper case letters may be displayed. The significance of using a consistent shape for letters (i.e., all lower case or all upper case) is described below.

FIG. 5 shows other examples of hexagonal arrays of keys corresponding to the other subsets of English letters and keywords corresponding to the letters. Hexagonal array, also referred to as vowel-daisy, 502 has a key for the vowel “e” and graphical icon of the keyword “egg” to demonstrate the intended phonetic sound for the letter (i.e., “eh” for egg as opposed to, for example, “ee” in eel). The center key for “e” is surrounded by consonant keys for the letters d, r, p, f, h, and n, each with their own keywords. Hexagonal array or vowel-daisy 504 has a key for the vowel “i” surrounded by consonant keys for the letters j, m, t, n, g, and w, each with their own keywords. Vowel daisy 506 has a key for the vowel “o” surrounded by consonant keys for the letters f, p, d, t, l, and s, each with their own keywords. Vowel daisy 508 has a key for the vowel “u” surrounded by consonant keys for the letters g, n, b, f, r, and q, each with their own keywords.

Before describing the complete vowel-daisy keyboard of the described embodiment which combines keyboard configurations shown in FIGS. 4 and 5, plus additional edge keys, it is useful to describe one methodology for creating the vowel-daisies which comprise the keypad. In one embodiment, the keypad is created by first studying the frequency of occurrence of what is referred to as n-grams (single letters), bi-grams (pairs of letters), tri-grams (sets of 3 adjacent letters) and words in large bodies of text. For example, the first one million words in the Brown Corpus or words in the Google Corpus, which contains 155 billion words, may be used. The purpose of this study or analysis is to find an optimal array of letters for efficiently entering text into computer programs. In one embodiment, the letters are arranged in a hexagonal array as described above to optimize the number of letters that may be reached from a single letter. As noted, the letters are also arranged so that each vowel is surrounded by six consonants, the vowel-daisy.

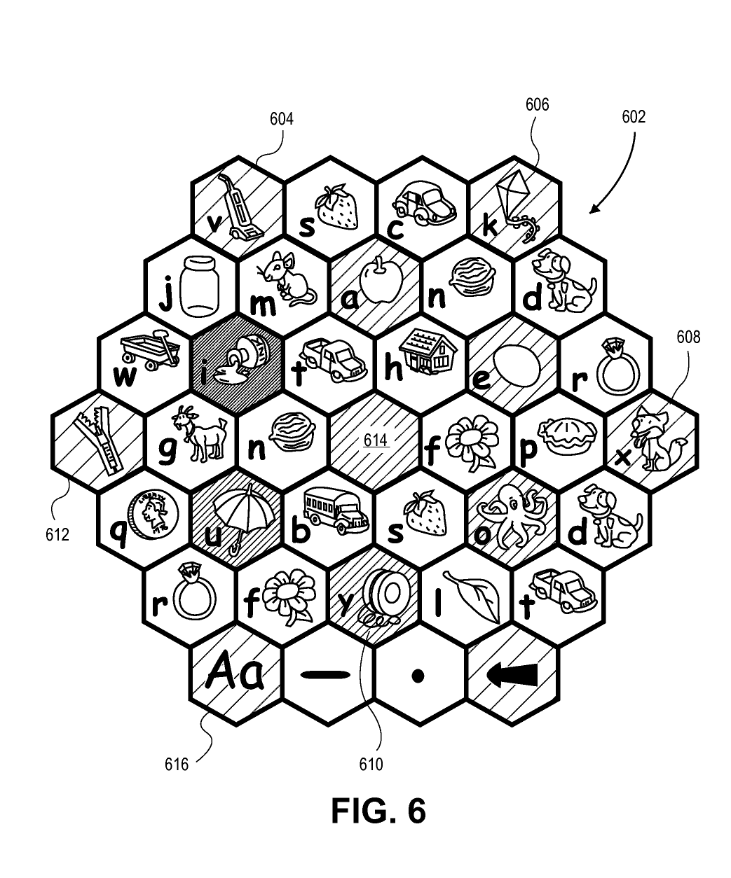

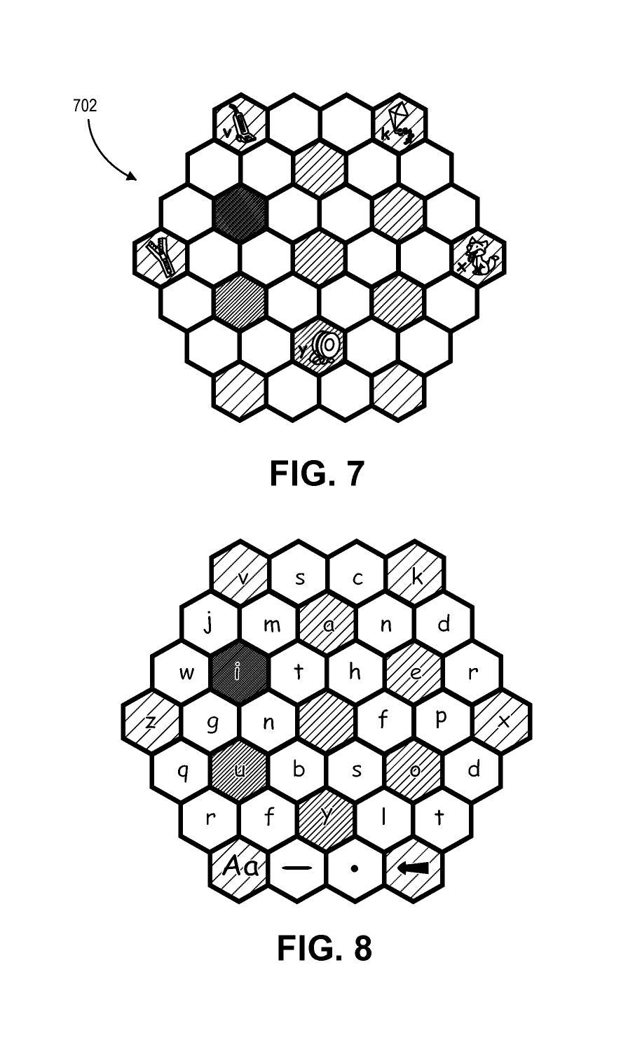

Vowel-daisies shown in FIGS. 4 and 5 are combined to create a novel keyboard that is highly efficient and effective for learning to read, write and spell in English and entering text. FIG. 6 shows an example of a keyboard 602 comprised of five vowel-daisies (402, 502, 504, 506, and 508) and five consonant letters, referred to as edge letters, not included in the individual daisies. These edge letters are hexagonal keys for the consonants v (604), k (606), x (608), y (610), and z (612), each with a keyword and in lower case, as in the other letter keys. FIG. 7 is an illustration of the keyboard 702 showing the edge letters. There is also a blank key 614 in the center of keyboard 602. In other embodiments the arrangement of consonant keys 604-612 (the keys shown in FIG. 7) may be different. FIG. 8 is an illustration of the keyboard showing only the letters without the keyword pictures in accordance with an alternative embodiment. In yet other embodiments, the arrangement of the vowel-daisies comprising keyboard 602 may be different. Key 616 may be used to toggle between lower and upper case letters. If activated, the letters may be displayed in upper case. The case of a letter, referred to here as the shape of the letter, is considered another characteristic attributed to the letter. As described below, it is important when learning to read in English or learning a new language to keep the options or variations limited. In this respect, it is important for the user to hear one consistent sound and see one consistent shape for each letter.

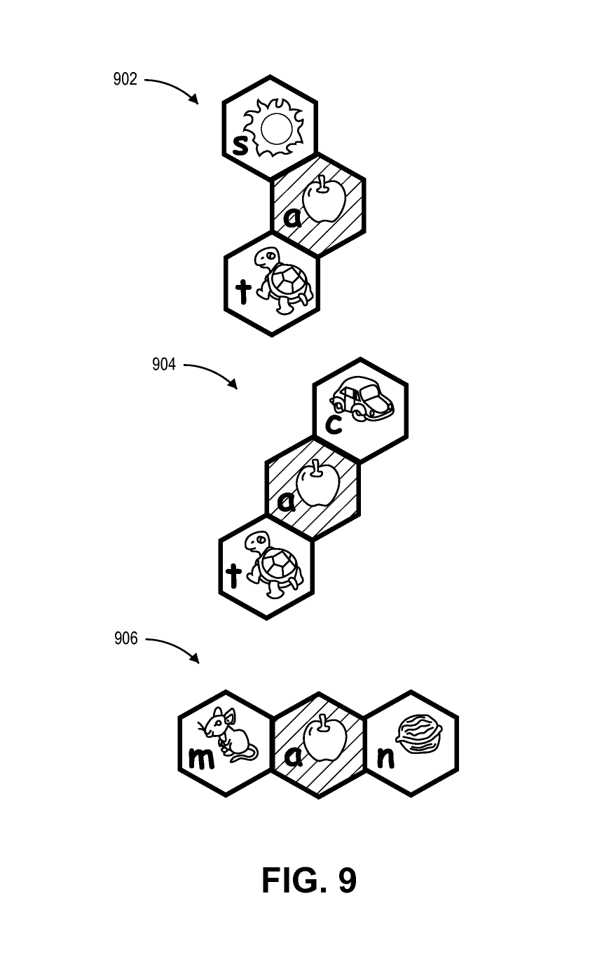

FIG. 9 is a series of illustrations showing sample 3-letter segments forming words (daisy words) from the “a” vowel-daisy. Sample segment 902 shows the word “sat”, segment 904 shows the word “cat”, and segment 906 shows the segment “man”. These are illustrative of how words can be spelled from the keyboard using the “a” vowel daisy as an example. A user can swipe her finger across the letter keys to type these words and get audio and visual feedback for each sound while swiping and for the word as a whole when completed. Other examples of word lists that derive from all five vowel-daisies are provided below.

In one embodiment, the letters may be arranged and re-arranged, forming vowel daisies using n-gram frequency charts and using models to mock up a complete keypad taking into consideration various color coding schemes. Word lists are generated from the arrays, with many variations. The keypad's hexagonal array is optimized for use with any alphabetical language by entering sample words into the program.

Daisy Words are 3-letter words that have one sound (or phoneme) for each letter of the word. The phonemes in daisy words are short vowels, such as “a” in “cat,” and the one main (most frequently used) phoneme for each consonant, such as “c” in “cat” not in “cell.” If two letters form one sound (or phoneme) in a word, such as “th-” in “the,” or “-dd” in “add,” they are not daisy words. Daisy words do not use pairs of vowels for one sound, such as “ai-” in “aim,” or “-oy” in “boy.” Daisy words do not use certain letters that change the sound of the vowel, such as “ar-” in “art” and “-ow” in “bow.” Daisy words can be sounded-out with one sound for each letter of the word, such as “c-a-t,” for “cat.” This one-to-one correspondence between letters to sounds in daisy words makes English consistent so it's much easier to learn to read, write and spell at an early stage.

Word lists from the vowel daisies are shown in Table 1 below.

TABLE 1

| | Daisy Words | Not Daisy Words | |
|---|---|---|---|
| a | act | abs | |
| | aft | ace | |
| | amp | ado | |
| | and | ads | |
| | ant | age | |
| | ask | ago | |
| | asp | aid | |
| | apt | ail | |
| | | aim | |
| | | air | |
| | | ait | |
| | | all | |
| | | any | |
| | | ape | |
| | | arc | |
| | | are | |
| | | ark | |
| | | arm | |
| | | art | |
| | | ash | |
| | | ate | |
| | | auk | |
| | | awe | |
| | | awl | |
| | | add | |
| a-words | 8 | 25 | 33 |
| b | bad | bah | |
| | bag | bye | |
| | but | buy | |
| | bus | boy | |
| | bun | bow | |
| | bud | boo | |
| | box | | |
| | bot | | |
| | bop | | |
| | bob | | |
| | bit | | |
| | bin | | |
| | big | | |
| | bet | | |
| | beg | | |
| | big | | |
| | bib | | |
| | bet | | |
| | beg | | |
| | bed | | |
| | bat | | |
| | ban | | |
| | bam | | |
| | bug | | |
| b-words | 24 | 6 | 30 |
| c | cud | cue | |
| | cox | cry | |
| | cot | coy | |
| | cop | cow | |
| | cog | coo | |
| | cot | chi | |
| | cop | caw | |
| | cog | car | |
| | cod | | |
| | cob | | |
| | cat | | |
| | cap | | |
| | can | | |
| | cam | | |
| | cab | | |
| | cut | | |
| | cup | | |
| c-words | 17 | 8 | 25 |
| d | dam | day | |
| | dot | duo | |
| | dig | due | |
| | din | dog | |
| | dun | duh | |
| | dug | | |
| | dud | | |
| | don | | |
| | dub | | |
| | dip | | |
| | dim | | |
| | did | | |
| | dib | | |
| | den | | |
| | dad | | |
| | dab | | |
| d-words | 16 | 5 | 21 |
| e | elm | emu | |
| | elf | erg | |
| | end | era | |
| | elk | eon | |
| | | eke | |
| | | eel | |
| | | ego | |
| | | egg | |
| | | eye | |
| | | ewe | |
| | | eve | |
| | | err | |
| | | ebb | |
| e-words | 4 | 13 | 17 |
| f | fad | far | |
| | fat | fee | |
| | fax | few | |
| | fed | fie | |
| | fen | fir | |
| | fez | fly | |
| | fan | foe | |
| | fig | fog | |
| | fin | fon | |
| | fit | for | |
| | fix | fur | |
| | fox | fry | |
| | fun | | |
| | fob | | |
| f-words | 14 | 12 | 26 |
| g | gap | guy | |
| | gas | gym | |
| | got | gem | |
| | get | gel | |
| | gig | goo | |
| | gob | gnu | |
| | gum | gee | |
| | gut | | |
| | god | | |
| g-words | 9 | 7 | 16 |
| h | had | has | |
| | hid | hay | |
| | ham | her | |
| | hat | hew | |
| | hem | hey | |
| | him | his | |
| | hip | hoe | |
| | hit | how | |
| | hen | hoy | |
| | hog | hue | |
| | hop | huh | |
| | hot | | |
| | hub | | |
| | hug | | |
| | hum | | |
| | hut | | |
| h-words | 16 | 11 | 27 |
| i | imp | ill | |
| | ink | ice | |
| | ilk | icy | |
| | its | inn | |
| | | ion | |
| | | ire | |
| | | irk | |
| i-words | 4 | 7 | 11 |
| j | jab | jar | |
| | jag | jaw | |
| | jam | jay | |
| | jet | joy | |
| | jib | | |
| | jig | | |
| | job | | |
| | jog | | |
| | jot | | |
| | jug | | |
| | jut | | |
| j-words | 11 | 4 | 15 |
| k | kid | koi | |
| | kin | key | |
| | kit | koa | |
| | keg | | |
| | kob | | |
| k-words | 5 | 3 | 8 |
| l | lab | law | |
| | lad | lay | |
| | lag | lea | |
| | lap | lei | |
| | lax | lie | |
| | led | low | |
| | leg | lye | |
| | let | log | |
| | lid | | |
| | lip | | |
| | lit | | |
| | lob | | |
| | lop | | |
| | lot | | |
| | lug | | |
| l-words | 15 | 8 | 23 |
| m | mac | mar | |
| | mad | maw | |
| | man | may | |
| | mat | mic | |
| | max | mod | |
| | men | moo | |
| | met | mow | |
| | mid | | |
| | mix | | |
| | mob | | |
| | mom | | |
| | mop | | |
| | mod | | |
| | mud | | |
| | mug | | |
| m-words | 15 | 7 | 22 |
| n | nab | new | |
| | nag | nor | |
| | nap | now | |
| | net | | |
| | nib | | |
| | nil | | |
| | nit | | |
| | nix | | |
| | nob | | |
| | nod | | |
| | nub | | |
| | nog | | |
| | not | | |
| | nun | | |
| | nut | | |
| n-words | 15 | 3 | 18 |
| o | oft | oaf | |
| | opt | oak | |
| | owl | oar | |
| | | oat | |
| | | odd | |
| | | ode | |
| | | off | |
| | | ohm | |
| | | oil | |
| | | old | |
| | | one | |
| | | ore | |
| | | our | |
| | | out | |
| | | ova | |
| | | owe | |
| | | own | |
| o-words | 3 | 17 | 20 |
| p | pad | par | |
| | pal | paw | |
| | pan | pay | |
| | pat | pea | |
| | peg | per | |
| | pen | pew | |
| | pep | pie | |
| | pet | ply | |
| | pig | poi | |
| | pin | pow | |
| | pit | pox | |
| | pod | pro | |
| | pop | pry | |
| | pot | put | |
| | pug | | |
| | pun | | |
| | pup | | |
| | pix | | |
| | pic | | |
| p-words | 19 | 14 | 31 |
| q | | qua | |
| q-words | 0 | 1 | 1 |
| r | rad | raw | |
| | rag | ray | |
| | rat | roe | |
| | red | rue | |
| | rib | rye | |
| | rim | row | |
| | rip | | |
| | rob | | |
| | roc | | |
| | rod | | |
| | rot | | |
| | rub | | |
| | rug | | |
| | run | | |
| | rut | | |
| r-words | 15 | 6 | 21 |
| s | sac | saw | |
| | sad | say | |
| | sag | sea | |
| | sap | see | |
| | sat | sew | |
| | sax | she | |
| | set | shy | |
| | sim | sir | |
| | sip | ski | |
| | sis | sky | |
| | sit | sly | |
| | six | son | |
| | sob | sow | |
| | sop | soy | |
| | sub | spa | |
| | sum | spy | |
| | sun | sue | |
| | sup | | |
| s-words | 18 | 17 | 35 |
| t | tab | tar | |
| | tad | tea | |
| | tag | tee | |
| | tam | the | |
| | tan | tie | |
| | tap | toe | |
| | tat | ton | |
| | tax | tow | |
| | ten | toy | |
| | tic | try | |
| | til | tui | |
| | tin | two | |
| | tip | | |
| | tom | | |
| | top | | |
| | tot | | |
| | tub | | |
| | tug | | |
| | tut | | |
| t-words | 19 | 12 | 31 |
| u | ump | uke | |
| | | urn | |
| | | use | |
| u-words | 1 | 3 | 4 |
| v | van | vee | |
| | vat | via | |
| | vet | vie | |
| | vex | vow | |
| | vim | | |
| v-words | 5 | 4 | 9 |
| w | wag | wad | |
| | web | wan | |
| | wed | war | |
| | wet | was | |
| | wig | wee | |
| | win | who | |
| | wit | why | |
| | | woe | |
| | | won | |
| | | woo | |
| | | wow | |
| | | wry | |
| | | wye | |
| w-words | 7 | 13 | 20 |
| x | | | |
| x-words | 0 | 0 | 0 |
| y | yak | yaw | |
| | yam | yay | |
| | yap | yea | |
| | yen | yew | |
| | yep | you | |
| | yes | yow | |
| | yet | | |
| | yen | | |
| | yip | | |
| | yum | | |
| | yup | | |
| y-words | 12 | 6 | 18 |
| z | zag | zee | |
| | zap | zoo | |
| | zed | | |
| | zen | | |
| | zip | | |
| | zig | | |
| z-words | 6 | 2 | 8 |

As noted, the array of keys can be hexagonal, as in the described embodiments, or circular, with one vowel surrounded by six consonants in an order that allows forming words by swiping a finger across the array as displayed on a touch-screen of a mobile device. The keypad may be used and revised in order to optimize the array of letters using software.

As shown in the figures, the keypad may be illustrated with keywords (graphical icons) so that users, such as children, learning to read can see keyword pictures for each letter of the alphabet and learn how to pronounce the letter. As noted, the keyword pictures are selected based on the beginning or starting sound of the keyword (e.g., “aa” for apple).

Software for implementing the keypad is installed onto the mobile device and games and activities for introducing each keyword picture, letter shape and sound (phonetic data items), and each of the five vowel daisies and edge letters are rendered on the display. The keypad may be used not only to enter text but as a tool to teach reading, writing, and spelling. Some of these games and activities are described below.

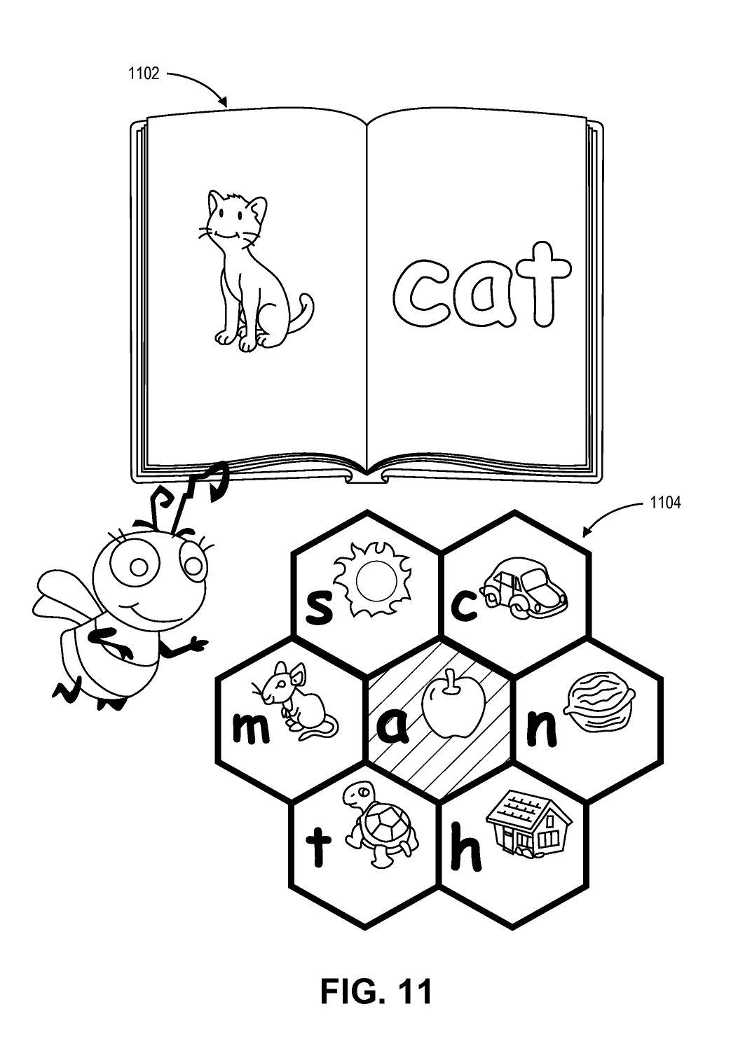

FIG. 11 is a sample screenshot of a wordbook 1102 showing a keyword picture and keyword, a vowel daisy 1104 for the letter “a”, and an animated, child-oriented character (here, a “reader bee”) in accordance with one embodiment of the present invention. It shows an example of an array of letters that enables users to daisy-type (slide their finger across the daisy, swiping the letters of a word in order) to generate familiar words, such as cat, mat, hat, sat, tan, man, can, act, ant on the a-daisy. In this activity, children see one word in the wordbook, as shown above for “cat.” They daisy-type that word, e.g. sliding their finger over c-a-t or tapping the letters, and hear the sound of each letter, “c,” “a,” “t,” when they tap it or slide their finger across the letter. Then users slide their finger under the word in the wordbook, “cat” with prompts showing the reading direction (left to right). When users slide their finger under the word in the wordbook accurately, they hear the whole word spoken and see the picture that shows the word meaning, in this case, “cat” animated with a sound, such as “meow.”

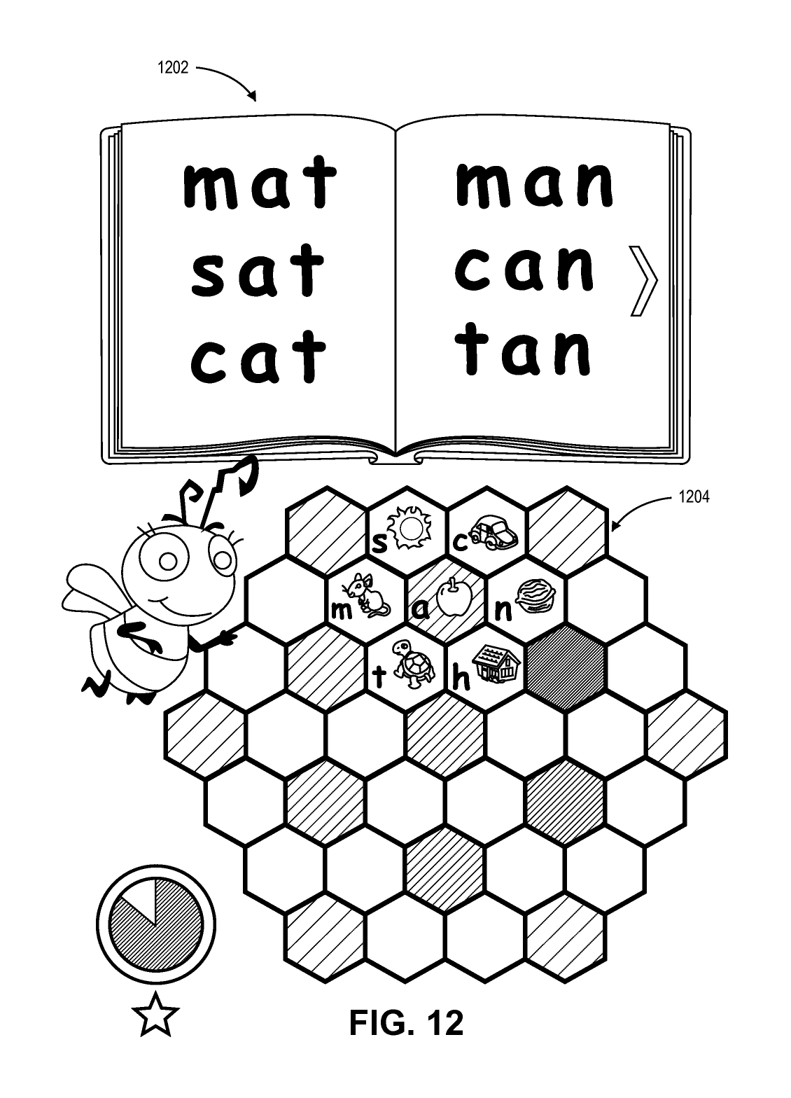

FIG. 12 is a sample screenshot showing a wordbook 1202 showing multiple words from the word lists for the “a” vowel daisy. The screen also contains an image of the complete keyboard 1204 with the “a” vowel daisy letters shown explicitly. Also displayed are a timer and an animated character (here, “Reader Bee”). The user can use this screen to type all the words they can in a set period, such as twenty seconds. They slide their finger over words on the a-daisy, generating words such as mat, sat, cat, man, can tan in the daisy-typing wordbook. They can type any 3-letter words that can be generated on the daisy, including daisy-words (that have one sound for each letter), which turn another color, such as blue, and other words that turn another color, such as yellow. The user can type unfamiliar words in the daisy-typing game, such as tat, tam and sac. Objectionable words, those words not commonly accepted in children's speech at school, “poof away” so they are not listed. The full daisy keypad is shown because when children start working with a second daisy, such as the e-daisy, they see both daisies on this array, and can make many more words with the combined daisies. As users play with another daisy, it appears in the typing game, as do edge letters when they work with them, so eventually the whole keypad is full, and approximately 492 3-letter words can be daisy typed by the user, depending on his or her speed in the game. This free typing activity allows users to apply their newly gained knowledge of letters and sounds in other activities while freely typing words they know or exploring generating words they do not know.

A software module, for example, in the form of an app executing on a mobile device, checks progress with every input (gesture, shake, tap, swipe) of the user and adapts dialog and character animation, for example, in the games and activities, to provide clues at various levels, based on the user's performance. Examples of activities and games are described below.

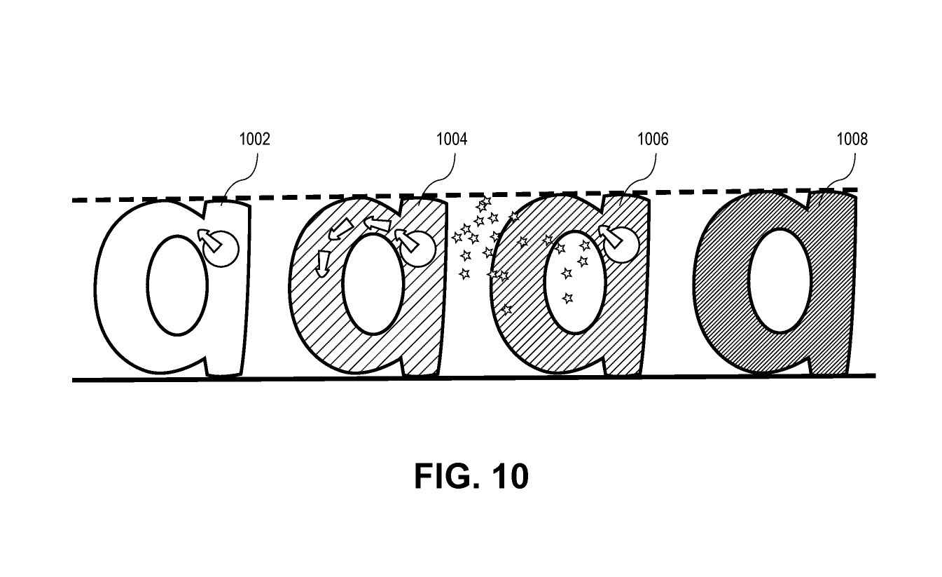

One activity is tracing an alphabet letter with the goal of learning to write in English. First the letter is auto-traced to show the user the stroke order and direction of forming the letter. The purpose is learning the shape of the lower-case letter. As users attempt to form the letter, for themselves, they are given clues for forming the letter correctly (top to bottom). For example, at clue level 1: a green dot appears at the starting point on a letter, and red dot at the end of the letter to be traced, with sound effects to draw attention to the letter's appearance (e.g., low sounds for low strokes and higher sounds for higher strokes), as shown in FIG. 10. FIG. 10 shows an example of the different stages of tracing the letter “a” from beginning to completion in accordance with one embodiment. A character in the software app (e.g., an animated, child-oriented character) on screen says, “Start at the green dot” as shown within 1002. At clue level 2, for example, colorful “marching arrows” appear starting at the beginning of the first stroke as shown in 1004. Once the user starts and traces the letter as shown in 1006, there may be visual effects (e.g., stars emitting from the letter) until he and completes it. At clue level 3 the letter fills in as shown in 1008 and completes with sound effects. The user can “trace along” or observe the strokes. The youngest users may be given a version that auto-traces the letters so they become familiar with letter shapes without being required to trace the letters.

The software notes whether a user has completed all her strokes of the letter in the correct order and direction, and offers the user another chance to complete the tracing accurately and independently if they make an error, such as drawing quickly and going outside the tracing areas defined for each segment of each letter in the app.

In one embodiment, the criterion for success is binary; either the user got everything right or did not for each letter and word. The app traces performance on every letter traced, every typing of a word on the daisy and swiping of a word in the wordbook.

The software, again in the form of an app in the described embodiment, provides a “throughput line” for learning via focused play. The user is hearing, seeing and touching letter shapes and sounds for each letter. The phonetic sound of a letter, which is not the name of the letter, is referred to as one phoneme or phonetic data item. The shape of the letter is referred to as an alphabetic data item. Using the software, a user relates seeing a letter, hearing a sound, and actively forming the shape of a letter with a finger on a touch-screen display of a device, invoking touch and a sense of flow and ease (for example, sparkles emit from the tip of the finger on a tablet writing surface, sounds give auditory feedback, voice of a character guides progress). The user checks the letter sound in rhyming words, encouraged to notice the shape made in the mouth (a proprioceptive muscular event) while forming sound. The multi-sensory approach using many parts of the body assures that users activate a variety of regions of their brains in quick succession, in some cases in less than one second. The tracing is programmed so that successful stokes (circles and lines in letters) are modeled quickly, then users trace letters easily (with a range of responses accepted, within parameters that assure that users learn the basic shape of each letter).

In one embodiment, immediately after tracing a letter and hearing the phoneme of the letter, that is, its sound spoken in the app, users see, hear and track what is referred to as a “Wizding letter person” so their “hunting instinct” is invoked, activating the medulla oblongata (base brain), alongside the other brain regions already invoked through seeing, hearing, and touching the letter. Combining these senses and muscles in users, and invoking many brain connections while they are highly focused and in a “flow state” (in users who are children, this is obtainable because play is fun and easy), enables very fast learning. Essential to this process of learning to read efficiently is having the software check continuously what the child knows and does not know and focus the user's attention on the next needed or required learning experience. In one embodiment, the software checks that the user accomplishes each task with complete accuracy (e.g., as noted above, either with 100% accuracy or not).

The user is also combining seven-letter sounds at a time into words. For example, three letters composed of consistent sounds that occur in consonant-vowel-consonant (CVC) words, short vowel sounds and one sound of a consonant, e.g., h-a-m and vowel-consonant-consonant (VCC) words, e.g. a-n-t. One step in the method is presenting no exceptions at this stage. As noted above, only sounds and letters with a one-to-one correspondence are presented: one sound and one shape per letter.

Users see and type three-letter words on the vowel-daisy, which is shaped to facilitate typing only words with vowels in the middle position (e.g., cat, hat) across the hexagonal or circular array. Or the user may type around it with the vowel at the beginning of a word (e.g., and, end), vowel-consonant-consonant (VCC) words. The user hears each letter in the initial, medial and final position of the word (c-a-t) while typing the word in the vowel daisy. The user may then immediately slide a finger under or on the word from left to right in a wordbook, see the letters change color and sparkle and also see an animation on the facing page of the wordbook that establishes the meaning of the word (the animation is activated by underlining the correctly typed word).

This blending of words through typing letters using the vowel daisy and hearing each sound (phonic data item), followed by tracing under words while hearing the blended sounds of a word, occurs within the first few minutes of using the app to learn to read. The progression from letters to words is unusually rapid and results, in part, by the proximity and focal value of the daisy letters (as described, six consonants around a vowel, isolated from other letters and used consistently).

The vowel daisies facilitate forming or writing words. Colors highlight each key or cell where the next letter will be typed as a clue when there is a delay, and the letter sound is spoken when the child touches the correct key of the vowel daisy. Only the phonetic sound of the letter, not the name of a letter, is spoken, preventing confusion that can occur when a user has learned the letter name and sound together along with a spoken keyword. When this occurs, the blending of the sounds of a word are confounded by the user mentally rehearsing: “c cuh cat, a ah apple, t tuh tree” and so on. Or the user is confused by hearing the sounds incorrectly spoken, e.g., cuh-ah-tuh for c-a-t. In the software, the user hears the simplest, most efficient and accurate sounds that compose 3-letter words and one sound only for each letter. This allows users to blend letters into words to experience themselves reading, and to gain confidence that decoding words can work. Other embodiments may include capital letters and more sounds for letters and combinations of letters, such as t-h-e, which don't follow the CVC sound-symbol correspondence rules, and 4-letter words for long vowels, combined letters for the many spellings of English, each with highly focused, clear activities.

After using the app for a short period (e.g., a few minutes) of experiencing individual letters and blending them into words, users see and hear the words that can be formed on each daisy in an illustrated story. The user taps the words on the story pages, causing visual and auditory effects such as having the meaning of words acted out. For example, when children tap, “cat sat,” an animation showing a cat sitting is triggered. The story provides an interesting broader context for words. As such, the letter to word to story sequence is invoked for each daisy. The repetition of this pattern becomes familiar and builds confidence as the user progresses from the a-daisy, to the e-daisy, i-daisy, o-daisy, and u-daisy, followed by letters on the edge of the keyboard, with parallel activities and stories for each.

In one embodiment, there are various activities that can be performed using the keyboard of the present invention. One activity may be referred to as “open the daisy”. The user performs the following action: touch an empty daisy cell to reveal a keyword picture and hear the initial sound of a keyword, then the whole word. There is one picture per alphabet letter, e.g. c-c-car for letter “c”, seven letters at a time (on the vowel daisy). Because the vowel daisies overlap on the keypad, there are fewer new keyword pictures and sounds to learn when the second and third daisies are introduced (e.g. n and h are on both the a-daisy and the e-daisy). All letters on a daisy are introduced, so all consonants are reviewed by the time all the daisies are introduced. This activity focuses attention on hearing the sounds of keywords and their names (e.g., m-m-mouse, f-f-fan). The keyword pictures are revealed. The user learns specific name of objects (e.g., apple, not fruit; car not Volkswagen). Successful performance is measured by a user touching each cell following a prompt to open keyword pictures on all seven cells for each daisy. There are five daisies and one set of edge letters on the keyboard. The software tracks which keyword pictures are successfully revealed and reports which activities on each vowel daisy are completed. When users are finished with a set of activities, such as opening and trying all the a-daisy activities, the program brings them back to try the items they did not complete, either due to errors that invoked clues, or to not attempting to complete all parts of the activity.

Another activity is keyword picture match. This activity involves the user turning over two cards to match keyword pictures in a memory/concentration card game. If the pictures on the cards match, the user hears the name of the picture and the matched cards poof away. If they do not match, the two different words (e.g. fan, sun) are spoken and the cards flip back over. The goal of the game is for the user is to find all matching cards. The purpose of the activity is for the user to hear the keywords and see the keyword pictures two more times. Criteria for successful performance may be measured by the user if he correctly finds all the keyword picture cards that match. In one embodiment, there are 2×3 and 3×4 array cards and seven keywords per vowel daisy. The software tracks completion of all matches for a vowel-daisy. This activity may be varied so that users match a sound card (e.g. tap card to hear a-a) to a picture card (tap to hear apple) for keywords.

Another activity is tracing letters, as briefly described above and in FIG. 10. The action taken by the user is tracing a letter top to bottom with correct stroke order and direction. The user learns the basic shape of letters (e.g., forming circles and lines in a “forgiving” way). Successful performance may be determined by tracing 1, 2, or 3 strokes for each letter in the correct order and direction to form letters “a” to “z. Letters are tracked one at a time. Specific letters that are not traced correctly are presented for the child to trace again later in the program.

Another activity may be referred to as taking letter characters “home.” This involves a letter character emerging from behind a letter and running away. The user catches the letter, hears its sound and takes it to the keyword picture on the daisy. The user matches the sound and shape of the letter to an initial sound of the keyword. Successful performance is measured by a user taking a letter character from “a” to “z” to their keyword pictures in the seven daisy cells (a to z) with appropriate prompts. In one embodiment, progress is recorded and tracked in this activity and the children as asked to trace the letter and take the letter character home again when they return to this activity.

Another activity involves matching pictures and letters. This involves the user playing a 3×4 match game with pairs of cards showing an initial letter and its picture (e.g., “s” and sun). This enables the user to practice matching letters and comparing their sounds with initial sounds of keywords. Successful performance may be measured by a user matching 26 letters to keyword pictures, 6 at a time (in one embodiment, on a 3×4 array of cards, with pairs of cards for letter and sound) before a timer times out. The software notes accurate matching of each letter to keyword pictures and reports successful matches and attempts for each set of seven letters on a vowel daisy.

Another activity involves spelling words from the vowel daisies. The user sees a 3-letter word on the screen in a wordbook, which includes four words (hat, cat, sat, mat) and one word pair (ant, hat) for each daisy (30 words and word-pairs for 6 daisies and the edge letters) for the first round of play, and additional words for subsequent rounds, until all familiar three letter words are typed and swiped. While the user types, he hears the sound of each letter. For each accurately typed word, the user is prompted to swipe the word to hear it spoken, and a prompt is given to insure correct left-to-right swiping (a user finger under word or through word) if the user makes an error in swiping direction. The learning purpose of this activity involves seeing 3-letter words, typing them on the vowel daisy, and hearing 26 sounds in initial, medial and final positions within the words (for all letters that appear in these positions (e.g. x does not start any 3-letter, familiar words). Criteria for successful performance may involve a user typing four 3-letter words and one pair of words for each vowel daisy and edge letters. The software tracks and records accurate typing of each word, as well as words that were not typed or swiped accurately and presents them later for the user to daisy-type and swipe in the wordbook again later.

Related to this activity is tracing under words. The user traces a finger under or through each word in a wordbook, left to right, and hears it spoken. The user can repeat stroking under or through the word to hear it again. In one embodiment, sparkle effects are displayed and color of the letter changes during the tracing. The benefit of this activity is the blending of the sound of letters to form a word. The user traces under all words in the wordbook, left to right. In one embodiment, there are 30 words in first set for 5 vowel daisies and edge letters and additional words in second sets. All common English 3-letter words that are not offensive or confusing (capitals, abbreviations) may be used. The app tracks which words are typed and traced under accurately and returns the user to play those not accurately traced again. It may also report how many words per vowel daisy were traced under accurately.

The two preceding paragraphs describe two parts of the same activity or game. The daisy-typing of 3-letter words involves both the vowel-daisy and a wordbook on the same screen. For example, the user sees a word, e.g. cat, with a picture, in the wordbook. The reader app gives visual and spoken clues to help the user daisy-type that word, e.g. “c-a-t.” Clues include the bee or other animated object flying up to the wordbook and saying, “See the word?” and flying down, pointing to the daisy, “Type the word on the daisy.” If the user types an incorrect letter, she hears that letter sound (first phonic data item or phoneme) and a clue, such as a purple flashing cell, showing where to type the first letter using the vowel daisy, referred to as daisy-type. The user daisy types “c” on the daisy, then hears the “c” sound spoken. When a letter of the word is accurately typed, that letter changes color in the wordbook, e.g. the letter “c” in “cat” changes color in the wordbook. When all 3 letters are daisy-typed accurately, the guide character directs the user to slide her finger under the word in the wordbook. Clues include left to right colorful arrows under the word if the user does not slide her finger left to right. When the whole word is typed accurately, the word is pronounced and an animation of the picture occurs, e.g. the cat meows, moves it's whiskers and wags its tail.

While doing this activity, the user chooses letters to spell and type a word, hears each of the 3 phonemes for letters in that word spoken in isolation, uses her finger to trace left to right (the reading direction), thus blending the letters into a word. The word is spoken and illustrated with an animation (in case the child does not know that word).

This activity involves several parts of the user's brain, the parieto-temporal area for analyzing words by pulling them apart and linking the letters to their sounds (necessary for early reading), Broca's area for organizing speech. When the user finds these words in a story, then types them freely and comes back to play again, she begins to use the occipito-temporal area for rapidly and automatically recognizing a word on sight, a mark of fluent readers.

Another activity may be referred to as matching words. Here the user plays a card matching game using a 3×4 array and words for each vowel-daisy or for combined vowel daisies that were completed. Words and pictures and words (where a picture can illustrate the word) may be used. Returning to a vowel daisy can cause more words to be used. The learning purpose of the activity is checking whether a user can hear the match between word and word for pictures and printed words. The user succeeds if the he matches word to word, illustration or text for all three-letter words on each vowel daisy and edge letters. The software tracks and records which matches are made and presents the next sets of words in the game.

Another activity is typing words on the daisy, seeing them in a book, and speaking or saying the words the user has typed while the app records them then plays them back. Here the user starts with one daisy and generates as many words as he can during a timed period, such as 20 seconds. The user spells and types up to 16 words using the a-daisy. The user then taps the record button, records his words and hears them played back. As the user begins using other daisies, the new daisy is added to letters available in the typing game. Users can type more words when they have more letters. In one embodiment, the number of words may reach 492 in total. Through this activity, the user types, spells, and reads 3-letter words in English that are familiar to users, specifically children. The user reads the word sets aloud. Successful performance can be measured by a user typing and spelling sets of 3-letter words. For example, parents can listen to a child's recordings of words to check accuracy. The software tracks every 3-letter word that is typed for accurate choice of words and spelling. The app also reports how many words are recorded and will attempt speech recognition to track accuracy of user's reading of words aloud. The app will report how many words were created, and which ones (so user can read the lists to others, such as parents or teachers). The app “poofs away” objectionable words.

One activity involves a story text and finding vowel daisy words in the text. After a user hears a story page, he finds 3-letter daisy-words, shown in a large, blue font, in the story text and taps the daisy-words to see an animation showing the meaning of the word. Here, the same words that the user typed and heard sound by sound, blended by tracing under the words and hearing the word, sees animations illustrating the meaning of the words, then hears in a story and finds and identifies in this richer context (the story text). This way the user can apply what he learned in a new situation, gaining confidence and enjoying the ease of reading many words. This is done without being confused by too much information; as noted above, all words have one sound for each letter, and one shape, such as lower case letters. The app checks whether the user finds all the 3-letter daisy words. Each word is noted and the app reports list of words found in the story.

In one embodiment, the app of the present invention executing on a mobile or other computing device provides a method of teaching skills, starting with awareness and giving users a chance to move through stages of learning that forms a firm base for later learning. The method may be applied to other skills of reading, learning capital letters, learning letter combinations like /th/in /the/ (voiced) and /thick/ (voiceless), learning long vowel sounds and their spelling variations (using color coding), building vocabulary and increasing comprehension through integrated sets of experiences on screen and off. The method utilizes small steps that the users can accomplish confidently. The same series of steps can be used for learning English as a Second Language for foreign language speakers.

In other embodiments, games are provided with content appropriate for the skills and concepts being introduced and practiced. A few game formats may be used for all the games. To arrange the games, it is useful to define what is being learned at each step so it can be appropriately assessed, enhanced and applied in new situations to afford transfer of learning.

The primary activities in app and process skills related to reading, writing, and spelling are provided in Table 2 below.

TABLE 2

| | Activity | Reading Skills/Concepts | Process Skills |
|---|---|---|---|
| 1 | See keyword pictures | Pictures can illustrate specific | Follow directions (use purple |
| | (one per alphabet | words (e.g., apple, not fruit). | clues, wait briefly to proceed, |
| | letter), hear them and | Words have a first sound; users | get used to the rhythm and |
| | their first sounds | can hear and notice the first | timing of the games). |
| | | sound of keywords that will be | |
| | | used for finding letters and | |
| | | typing letters | |
| 2 | Write letters | Letters are made of curves and | Follow directions (e.g., start |
| | | straight lines; to write lower case | at the green dot, follow the |
| | | letters, users start at the top, | arrows, write to the end of |
| | | write the left part of the letter | the curve or line; stay inside |
| | | first, then the rest of the letter. | the letter outline; try again a |
| | | | little more slowly). |
| 3 | Place letter characters/ | Each letter has a shape and a | Pick up moving letter |
| | people on keyword | sound; children match the letter | characters and move it to a |
| | pictures | to the first sound of a word | chosen destination while |
| | | shown in a picture. Seven letters | thinking about where it goes |
| | | are given the a-daisy, one at a | to match a picture. Listen to |
| | | time, then five new letters in the | the clue about letter sound |
| | | e-daisy, and fewer going | and name of pictures. |
| | | forward, adding up to 26 letters. | |
| | | Move from letters to sounds. | |
| 4 | Spell and type 3-letter | Look at a word in a book; type 3 | Manual dexterity for typing |
| | words (on a vowel | letters of that word in order; | words. |
| | daisy) | listen to 3 sounds that make up | |
| | | the word. Focus on letter sounds | |
| | | being spoken when letters are | |
| | | touched; realize that letters make | |
| | | sound sin words. Spell dozens | |
| | | of words. Move from separate | |
| | | letters to spoken sounds and | |
| | | letters in words. | |
| | | Users can “daisy type” 3-letter | |
| | | words easily because six | |
| | | consonants are arranged around | |
| | | a vowel. The letters are | |
| | | arranged so users can find | |
| | | familiar words easily, then put | |
| | | the whole array (all the daisies) | |
| | | together for later lessons. | |
| 5 | Slide finger over words | Letter sounds can be blended | Use visual, auditory, and |
| | in a book, left to right, | together to make words. Letters | kinesthetic approach to |
| | hear words and see | in words are read left to right. | learning the same word. |
| | animation | Separate sounds can be blended | Trace finger left to right on |
| | | together to make words. Users | or under words. Users |
| | | see animated illustrations to | change from sliding their |
| | | clarify word meanings. Move | fingers over words in a |
| | | quickly from spoken letter | wordbook, back to typing |
| | | sounds to spoken words that | words on the daisy, requiring |
| | | have meaning. | a change of focus. Turn page |
| | | | using arrow. |
| 6 | Listen to an engaging | Enjoy listening to a story. Hear | Explore and touch pictures |
| | story that uses words | familiar words in a rich language | and words in the story. |
| | users recently learned | context, making many brain | Enjoy causing animations to |
| | to read, type and spell | connections for new words. | occur through touch. |
| | | Find these words in the text and | |
| | | daisy-type them. Move from | |
| | | separate words to words in | |
| | | sentences in a story. Enjoy | |
| | | hearing rhyming words and a | |
| | | poem with a rhyme scheme. | |
| | | Repeat the story and join in, | |
| | | saying fun words like “Poof!” | |
| 7 | Freely type 3-letter | Apply the skills learned in | Type freely (on the daisy |
| | words using one, then | typing single words and finding | keyboard) using gradually |
| | two, three, four, and | them in stories to generating | more letters, up to all 26 |
| | five daisies, then on all | words freely, both daisy words | letters of the alphabet in |
| | 26 alphabet letters. | and other words (any of 500+ | English. |
| | Type daisy-words, | acceptable 3-letter words in | |
| | those with one | English). | |
| | consistent sound per | Read 3-letter word generated | |
| | letter (these turn blue), | while typing and hear your voice | |
| | and other words, such | played back saying the words. | |
| | as “the, has, one.” Tap | | |
| | the record button, read | | |
| | the words you typed, | | |
| | hear them played back. | | |

In one embodiment, the app of the present invention provides various games. One is for improving memory. On the display of a mobile device, a user sees cards with stars on their backs, in a rectangular array, starting with 2×3. The app audibly recites “Match the cards. Touch two cards to turn them over.” The user touches two cards to turn them over and the app recites, for example, “hat” (for the pictures of the hat) and “hat” for the word, “hat”. If the user does not touch any cards for x seconds, e.g., 2 seconds, random cards blink a certain color and make a sound. When two cards are face up, the user looks at the cards for x seconds (settable time) to see whether the faces of the cards match. If the cards match, there is a one second pause while stars sparkle and the music plays, then the cards disappear from the screen with an appealing sound. If the cards do not match, they turn over so their backs are showing. If the user touches a third card or more cards during play, nothing happens.

When all matches are made, the app recites for example “You won the game! You leveled up!” The user gets a second array of cards, 2×4, with new, appropriate content. After winning that, a larger array is presented and so on.

The size of the array of cards and content of the “face cards” (picture and picture, picture and letter, picture and word, etc.) may vary according to how far the children have progressed in the app.

When the games are being played, there is a pull-down menu at the top of the page showing a home page and five games (letter sounds, letter shapes, words, story and daisy-typing). Users can choose any of the five games to play for one daisy. To reach another daisy, users go to the home screen and pull down a menu showing the five vowel daisies and the edge letters.

Other games involve rhyming words using the vowel daisies. A user clicks a spinner to select a word type, e.g., “at”. A picture of a cat is displayed with three blanks spaces under it for the user to enter three rhyming words.

Example embodiments of a keypad and methods for learning to read, spell, write, and perform other educational functions related to language are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

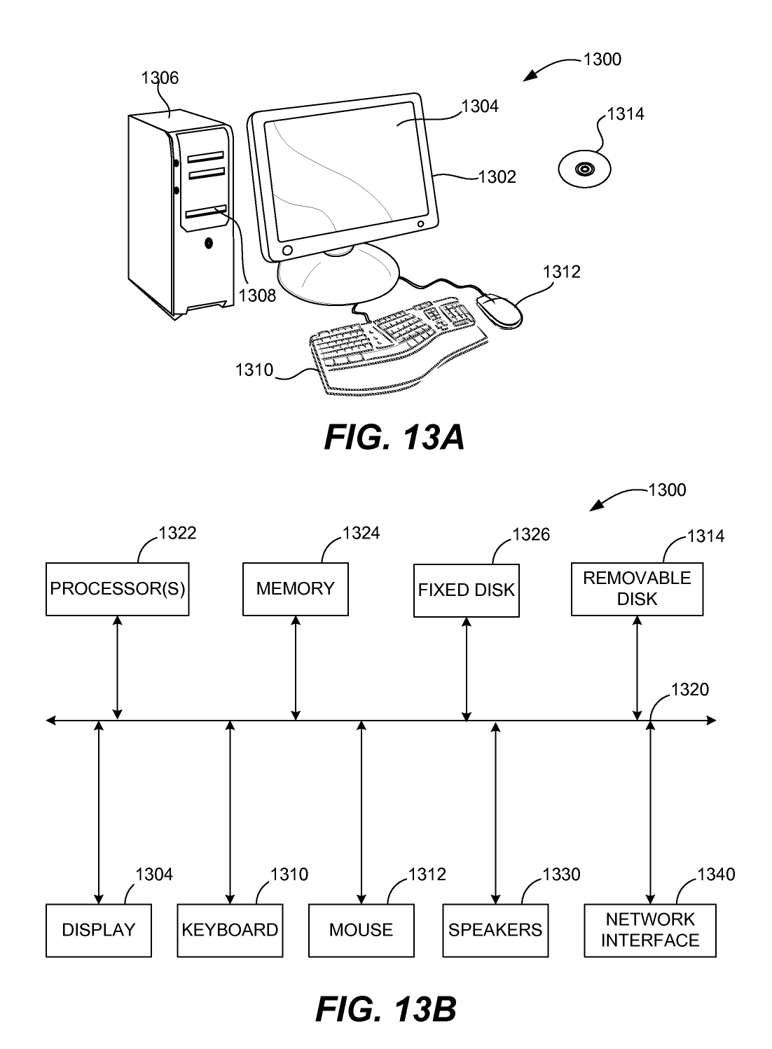

FIGS. 13A and 13B illustrate a generic computing system 1300, such as a mobile device, suitable for implementing specific embodiments of the present invention. Some of the devices that can be used in the present invention may have other features or components that are not shown in FIGS. 13A and 13B and not all the components shown in these figures (e.g., the keyboard) are needed for implementing the present invention. As such, FIG. 13A shows one possible physical implementation of a computing system as this term is broadly defined.

In one embodiment, system 1300 includes a display or screen 1304. This display may be in the same housing as system 1300. It may also have a keyboard 1310 that is shown on display 1304 (i.e., a virtual keyboard) or may be a physical component that is part of the device housing. It may have various ports such as HDMI or USB ports (not shown). Computer-readable media that may be coupled to device 1300 may include USB memory devices and various types of memory chips, sticks, and cards.

FIG. 13B is an example of a block diagram for computing system 1300. Attached to system bus 1320 is a variety of subsystems. Processor(s) 1322 are coupled to storage devices including memory 1324. Memory 1324 may include random access memory (RAM) and read-only memory (ROM). As is well known in the art, ROM acts to transfer data and instructions uni-directionally to the CPU and RAM are used typically to transfer data and instructions in a bi-directional manner. Both of these types of memories may include any suitable of the computer-readable media described below. A fixed disk 1326 is also coupled bi-directionally to processor 1322; it provides additional data storage capacity and may also include any of the computer-readable media described below. Fixed disk 1326 may be used to store programs, data and the like and is typically a secondary storage medium that is slower than primary storage. It will be appreciated that the information retained within fixed disk 1326, may, in appropriate cases, be incorporated in standard fashion as virtual memory in memory 1324.

Processor 1322 is also coupled to a variety of input/output devices such as display 1304 and network interface 1340. In general, an input/output device may be any of: video displays, keyboards, microphones, touch-sensitive displays, tablets, styluses, voice or handwriting recognizers, biometrics readers, or other devices. Processor 1322 optionally may be coupled to another computer or telecommunications network using network interface 1340. With such a network interface, it is contemplated that the CPU might receive information from the network, or might output information to the network in the course of performing the above-described method steps. Furthermore, method embodiments of the present invention may execute solely upon processor 1322 or may execute over a network such as the Internet in conjunction with a remote processor that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

What I claim is:

1. A method of learning to read and write English, the method comprising:
presenting a story emphasizing a specific word on a device having a processor, a memory, and a touch-activated screen;
receiving a response from a user when the specific word is highlighted in the story;
displaying a letter configuration that includes the specific word; and
manifesting a first phonic data item and a second phonic data item relating to a specific letter concurrently with displaying the letter configuration that corresponds to the word, the second phonics data item is one shape for the letter; and
presenting the first phonics data item and the second phonics data item at the same time, such that the user is presented with no other data, thereby preventing confusion when learning to read and write the letter.

2. A method as recited in claim 1 wherein receiving a response further comprises:
receiving tracing data indicating input of the one shape for the letter.

3. A method as recited in claim 2 further comprising:
displaying a first indicator of where to start tracing;
displaying a second indicator of how to trace the letter; and
displaying a third indicator of where to end tracing.

4. The method as recited in claim 2 further comprising:
displaying a letter character upon completion of receiving said tracing input from the user.

5. A method as recited in claim 2 further comprising:
displaying the letter configuration for the specific word upon completion of said tracing of the letter.

6. A method as recited in claim 1 wherein the letter configuration is one of a shape from a group comprising of hexagon, square, circular, diamond, triangular, pentagonal, octagonal, and rectangular, wherein the letter configuration is a plurality of consonants around a vowel.

7. A method as recited in claim 1 wherein the letter configuration is a “daisy-chain” arrangement.

8. A method as recited in claim 1 wherein the first phonic data item is a sound of the specific word.

9. A method as recited in claim 1 wherein the first phonic data item is a sound associated with a specific letter.

10. A method as recited in claim 1 further comprising:
manifesting the first phonic data item in multiple rhyming words.

11. A method as recited in claim 1 wherein the letter configuration is the “a” key surrounded by keys for s, c, n, h, t, and m, said letter configuration selected to allow for efficiently entering text.

12. A method as recited in claim 1 wherein the letter configuration is the “e” key surrounded by keys for n, d r, p, f, and h.

13. A method as recited in claim 1 wherein the letter configuration is the “i” key surrounded by keys for j, m, t, n, g, and w.

14. A method as recited in claim 1 wherein the letter configuration is the “o” key surrounded by keys for f, p d, t, 1, and s.

15. A method as recited in claim 1 wherein the letter configuration is the “u” key surrounded by keys for g, n, b, f, r, and q.

16. A method as recited in claim 1 wherein a first activity comprises seeing keyword pictures, hearing said keyword pictures, and hearing sounds.

17. A method as recited in claim 1 further comprising:
displaying a keyword graphic image corresponding to the specific word.

18. A method as recited in claim 3 wherein the second indicator is a marching arrow with sound and visual effects.

19. A system for teaching to read and write English, comprising:
a phonics generator module for providing phonics data relating to a word concurrently with displaying a vowel daisy, wherein the phonics data includes one sound for each letter in the word and one shape for each letter in the word; and
an audio component for presenting the one sound and the one shape at the same time, such that the user is presented with only the phonics data and no other data
a display component displaying a vowel daisy keyboard.

20. A system as recited in claim 19 wherein the hexagonal ring keyboard further comprises:
a first daisy array having an “a” key surrounded by keys for m, s, c, n, h, and t; a second daisy array having an “e” key surrounded by keys for h, n d, r, p, and f; a third daisy array having an “i” key surrounded by keys for w, j, m, t, n, and g; a fourth daisy array having an “o” key surrounded by keys for s, f, p, d, t, and 1; and a fifth daisy array having a “u” key surrounded by keys for q, g, n, b, f, and r;
in addition to letter keys for v, k, x, y, and z.

21. A system as recited in claim 19 wherein each key contains a keyword letter image.

22. An alphabet input device comprising:
a processor;
a network interface;
a memory;
a display component displaying:
a vowel key expressing a specific vowel with an image of an object corresponding to the vowel, which upon activation expresses the specific vowel;
a consonant key expressing a specific consonant with an image of an object corresponding to the consonant, which upon activation expresses the specific consonant; and
the vowel key adjacent to a plurality of consonant keys such that at least one consonant key is placed between two vowel keys forming a daisy chain arrangement.

23. The alphabet input device of claim 22, wherein said alphabet input device is a touch-activated device and contact by a user initiates activation.

24. The alphabet input device of claim 22, wherein said one or more vowel keys and one or more consonant keys have one shape chosen from a group comprising hexagonal, square, circular, diamond, triangular, pentagonal, octagonal and rectangular.

25. The alphabet input device of claim 22, wherein said plurality of consonant keys surrounding said one vowel key is selected to allow for efficiently entering words.

26. The alphabet input device of claim 25, wherein one vowel key is surrounded by a six consonant keys.

27. The alphabet input device of claim 26, wherein said one vowel key and six consonant keys are arranged in a hexagonal array.

28. A method of teaching writing, said method comprising:
activating an alphabet input device having a vowel key expressing a specific vowel with an image of an object corresponding to the vowel, which upon activation expresses the specific vowel;
a consonant key expressing a specific consonant with an image of an object corresponding to the consonant, which upon activation expresses the specific consonant;
receiving a signal from said alphabet input device that a key, which expresses a letter, is activated;
providing directions to form said letter; and
receiving touch signals indicating tracing over said directions.

29. The method of teaching writing of claim 28, further comprising generating a first sound associated with said key;

30. The method of teaching writing of claim 28, wherein said providing directions includes displaying directions in the shape of curves and/or lines that form said letter.
